(19) United States
(12) Patent Application Publication
(10) Pub. No.: US 2006/0170632 A1
(43) Pub. Date: Aug. 3, 2006

(54) Drive method and device for light-emitting display panel

(75) Inventors: Masato Togashi, Yonezawa-shi (JP); Toshihiko Aoki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/342,608

(22) Filed: Jan. 31, 2006

(30) Foreign Application Priority Data
Feb. 1, 2005 (JP) 2005-025281

(51) Int. Cl. G09G 3/32

(52) U.S. Cl. 345/82

(57) ABSTRACT

There is provided a drive method and device for a light-emitting display panel which can reduce shadowing caused by an ON rate of light-emitting elements and a condition of dimmer setting to a level at which a problem is not posed. An analog video signal is supplied to a drive control circuit and an A/D converting circuit, and the analog video signal is converted into image data corresponding to each pixel in the A/D converting circuit. The image data is written in an image memory. The image data is read from the image memory every scanning operation, and the drive control circuit acquires a rate (ON rate of light-emitting elements in each scanning operation) of EL elements to be controlled to emit light. Non-scanning selecting voltage data is read from a look-up table on the basis of the ON rate and the dimmer setting data so that a non-scanning selecting voltage data in the non-scanning voltage setting unit is determined. The value of a current which transiently flows from a non-scanning selecting voltage source (reverse bias voltage source VM) at the beginning of light emission of the light-emitting elements by a decrease in ON rate to charge the light-emitting elements to be turned on to emit light is appropriately controlled, and shadowing is suppressed from occurring.

### BACKGROUND OF THE INVENTION

1. Field of the Invention

The present invention relates to a drive method and device which can be preferably applied to a passive matrix light-emitting display panel using a capacitive light-emitting element and, more particularly, to a drive method and device for a light-emitting display panel which can reduce degrees of occurrence of shadowing (horizontal crosstalk) caused by a change in ON rate of the light-emitting element to a level at which a practical problem is not posed.

2. Description of the Related Art

Along with the popularization of a mobile telephone, a personal digital assistant (PDA), and the like, a demand for a display panel which has a high definition image display function and which can realize a small thickness or a low power consumption increases. As a display panel which satisfies the demand, conventional liquid crystal panels are applied to a large number of products. On the other hand, in recent years, an organic EL (Electro-Luminescence) element which takes advantage of characteristics of a self light-emitting is practically used. The display panel draws attention as a next-generation display panel which is replaced with a conventional liquid crystal display panel. This is caused by a background in which an organic compound which can expect preferable light-emitting characteristics is used in a light-emitting layer of an element to achieve practical high efficiency and practical long life.

The organic EL element is basically formed such that a transparent electrode (anode) consisting of, e.g., ITO, a light-emitting function layer, and a metal electrode (cathode) consisting of an aluminum alloy or the like are sequentially stacked on a transparent substrate such as a glass substrate. The light-emitting function layer may be a single light-emitting layer consisting of an organic compound, a two-layer structure consisting of an organic hole transportation layer and a light-emitting layer, a three-layer structure consisting of an organic hole transportation layer, an organic light-emitting layer, and an organic electron transportation layer, or a multi-layer structure obtained by inserting a hole-implanted layer between the transparent electrode and the hole transportation layer or inserting an electron-implanted layer between the metal electrode and the electron transportation layer. Light emitted from the light-emitting function layer is guided outside through the transparent electrode and the transparent substrate.

The organic EL element can be electrically replaced with a configuration constituted by a light-emitting element having diode characteristics and a parasitic capacitive component coupled in parallel to the light-emitting element. It can be said that the organic EL element is a capacitive light-emitting element. When a light-emitting drive voltage is applied to the organic EL element, first, electric charges corresponding to the electric capacitance of the element flow into the electrode as a displacement current and are accumulated in the electrode. Subsequently, when the voltage exceeds a predetermined voltage (light-emitting threshold voltage=Vth) inherent in the element, a current begins to flow from one electrode (anode side of the diode component) to the light-emitting function layer. It can be understood that light emission occurs with an intensity which is in proportion to the current.

On the other hand, the organic EL element has a current-luminance characteristic which is stable to a change in temperature, and has a voltage-luminance characteristic which is highly dependent on the change in temperature. The organic EL element is considerably deteriorated when an overcurrent flows in the organic EL element, and has reduced emission lifetime. For this reason, the organic EL element is generally driven by a constant current. As a display panel using the organic EL element, a passive drive display panel in which elements are arranged in the form of a matrix has been practically used in part.

FIG. 1 shows a conventional passive matrix display panel and an example of a drive circuit therefor. The drive circuit has a form of cathode-line scanning/anode-line drive. More specifically, m data lines (to be also referred to as anode lines hereinafter) A1 to Am are vertically arranged, and n scan lines (to be also referred to as cathode lines hereinafter) K1 to Kn are horizontally arranged, and organic EL elements E11 to Emn indicated by parallel couplings between the symbol marks of diodes and capacitors are arranged at cross points (total of m×n points) of the data lines and the scan lines, so that a display panel 1 is constituted.

In the organic EL elements E11 to Emn constituting pixels, one terminals (anode terminals of equivalent diodes of the EL elements) are connected to the anode lines, and the other terminals (cathode terminals of equivalent diodes of the EL elements) are connected to the cathode lines with respect to the cross points of the vertical anode lines A1 to Am and the horizontal cathode lines K1 to Kn. Furthermore, the anode lines A1 to Am are connected to an anode line drive circuit 2 serving as a data drive, and the scan lines K1 to Kn are connected to a cathode line scanning circuit 3 serving as a scanning driver to drive the anode lines A1 to Am and the scan lines K1 to Kn.

The anode line drive circuit 2 includes constant current sources I1 to Im serving as ON-drive voltage sources operated by using a drive voltage from a drive voltage source VH and drive switches Sa1 to Sam serving as switching means. The drive switches Sa1 to Sam are connected to the constant current sources I1 to Im to supply currents from the constant current sources I1 to Im to the respective organic EL elements E11 to Emn arranged with respect to the cathode lines to be scanned.

The drive switches Sa1 to Sam are designed such that a voltage from a reset voltage source VAM or a voltage from a reference voltage point (ground voltage GND in this FIG. 1) serving as an OFF-drive voltage source can be supplied to the organic EL elements E11 to Emn arranged with respect to the cathode lines.

On the other hand, the cathode line scanning circuit 3 functioning as a scanning selection unit includes scan switches Sk1 to Skn serving as switching means are arranged with respect to the cathode lines K1 to Kn. The cathode line scanning circuit 3 is designed such that any one of a reverse bias voltage from a reverse bias voltage source VM mainly used to prevent crosstalk light emission or a voltage from the ground voltage GND serving as a reference voltage point can be supplied to a corresponding cathode line.

Control signals are supplied from a light-emission control circuit 4 including a CPU or the like to the anode line drive circuit 2 and the cathode line scanning circuit 3 through a control bus, respectively. On the basis of a video signal to be displayed, switching operations for the scan switches Sk1 to Skn and the drive switches Sa1 to Sam are performed. In this manner, the constant current sources I1 to Im are connected to desired anode lines while setting the cathode lines at the ground voltage in a predetermined cycle on the basis of the video signal to selectively cause the organic EL elements E11 to Emn to emit light, so that an image based on the video signal is displayed on the display panel 1.

In the state shown in FIG. 1, the second cathode line K2 is set to the ground voltage to set a scanning state. At this time, reverse bias voltages from the reverse bias voltage source VM are applied to the cathode lines K1 and K3 to Kn in a non-scanning state. In this case, when the forward voltage of the EL element in the scanning light-emitting state is represented by Vf, the voltages are set to satisfy a relationship given by: [(forward voltage Vf)−(reverse bias voltage VM)]<(light-emitting threshold voltage Vth). Therefore, the drive device operates such that EL elements connected to the cross points of driven anode lines and cathode lines which are not selected as scan lines are prevented from performing crosstalk light emission.

The respective organic EL elements arranged on the display panel 1 have parasitic capacitances, respectively. Since the organic EL elements are arranged in the form of a matrix at the cross points of the anode lines and the cathode lines, in an example in which several ten EL elements are connected to one anode line, a synthetic capacity which is equal to or larger than a capacity several hundred times each parasitic capacity when viewed from the anode line is connected to the anode line as a load capacity. The synthetic capacity conspicuously increases as the size of the matrix increases.

Therefore, at the beginning of an ON scanning period of the EL elements, the currents from the constant current sources I1 to Im through the anode lines are consumed to charge the synthetic capacity, time delay occurs to charge the load capacity until the load capacity sufficiently exceeds a light-emitting threshold voltage (Vth) of the EL elements. Therefore, that rising of light emission of the EL elements is disadvantageously delayed (slowed), has a problem. In particular, as described above, when the constant current sources I1 to Im are used as drive sources of the EL elements, the currents are restricted because the constant current sources are high-impedance output circuits on an operational principle, so that the rising of light emission of the EL elements is considerably delayed.

This decreases ON-time rates of the EL elements. Therefore, the substantial light-emitting luminances of the EL elements disadvantageously decrease. For this reason, in order to eliminate the delay of rising of light emission of the EL elements caused by the parasitic capacities, in the configuration shown in FIG. 1, an operation of charging EL elements to be turned on is performed by using the reverse bias voltage source VM.

FIGS. 2A to 2E show an ON-drive operation of EL elements including a reset period in which amounts of charge accumulated in the parasitic capacities of the EL elements to be turned on are zero. FIG. 2A shows a scanning synchronous signal. In this example, in synchronism with the scanning synchronous signal, a reset period and a constant current drive period (ON period) are set.

FIGS. 2B and 2C show voltages applied to an ON line and an OFF line of the anode lines connected to the anode driver (anode line drive circuit) 2 in the respective periods. FIGS. 2D and 2E show voltages applied to a scan line and a non-scan line of the cathode lines connected to the cathode driver (cathode line scanning circuit) 3 in the respective periods.

In the reset period shown in FIGS. 2A to 2E, the drive switches Sa1 to Sam serving as switching means included in the anode driver 2 supply voltages from the voltage source VAM to the anode line (ON line) corresponding to the EL elements to be ON-controlled as shown in FIG. 2B. The circuit is controlled such that a ground voltage GND serving as a reference voltage of the circuit is supplied to the anode line (OFF line) corresponding to the EL elements to be turned off as shown in FIG. 2C.

On the other hand, the cathode driver 3 is designed to apply reverse bias voltages VM to cathode lines (scan lines) to be scanned and cathode lines (non-scan lines) not to be scanned by the scan switches Sk1 to Skn serving as switching means included in the cathode driver 3 as shown in FIGS. 2D and 2E.

In the constant current drive period which is an ON period of the EL element, the drive switches Sa1 to Sam supply constant currents from the constant current sources I1 to Im to anode lines (ON lines) corresponding to EL elements to be turned on as shown in FIG. 2B. The ground voltage GND serving as a reference voltage of the circuit is set to anode lines (OFF lines) corresponding to EL elements to be turned off as shown in FIG. 2C.

On the other hand, the cathode driver 3 in the constant current drive period is controlled such that the scan switches Sk1 to Skn included therein set cathode lines (scan lines) to be scanned to the ground voltage GND as shown in FIG. 2D and apply the reverse bias voltage VM to the cathode lines (non-scan lines) not to be scanned as shown in FIG. 2E.

In the above configuration, the reverse bias voltage VM and the voltage source VAM satisfy a relationship given by: VM=VAM, in the reset period, an amount of charge accumulated in the parasitic capacities of all the EL elements connected to the ON line can be made zero. Immediately after the shift to the constant current drive period, currents transiently flow from the reverse bias voltage source VM into the EL elements to be turned on through EL elements which are not scanned, and the parasitic capacities of the EL elements to be turned on are rapidly charged. As a result, light emission of the EL elements to be turned on relatively quickly rise.

As described above, the passive drive display device which precharges EL elements to be ON-driven by using a reverse bias voltage is disclosed in the following Japanese Unexamined Patent Publication-No. 9-232074 or the like.

In the passive drive display device having the above configuration, it is known that so-called shadowing (horizontal crosstalk) in which light-emitting luminances of the EL elements corresponding to scan lines having different ON rates fluctuate depending on the ON rates of the EL elements occurs. FIGS. 3A and 3B and FIGS. 4A and 4B explain a state in which the shadowing occurs.

FIGS. 3A and 3B show a voltage application state to the EL elements in the reset period according to the timing chart shown in FIGS. 2A to 2E and a voltage application state to the EL elements in the constant current drive period according to the timing chart shown in FIGS. 2A to 2E. FIGS. 3A and 3B show a case in which the ON rate of the EL element is 100%. FIGS. 3A and 3B, for descriptive convenience, show supply states of voltages to the EL elements corresponding to the first, second, and mth anode lines and the first, second, and nth cathode lines.

As shown in FIG. 3A, in the reset period, all the scan switches Sk1 to Skn are connected to the VM side, and a reverse bias voltage VM is applied to the scan lines K1 to Kn. All the drive switches Sa1 to Sam are connected to the VAM side. In this case, the reverse bias voltage VM and the voltage source VAM satisfy a relationship given by: VM=VAM. Therefore, in the reset period shown in FIG. 3A, a voltage difference between both the ends of each of all the EL elements is eliminated, and an amount of charge accumulated in the parasitic capacity of the EL element becomes zero.

On the other hand, in the constant current drive period, as shown in FIG. 3B, a first scan line K1 to be turned on for scanning is set to the ground voltage GND through the scan switch Sk1, and the reverse bias voltage VM is continuously applied to the other scan lines through the scan switches Sk2 to Skn. At this time, all the drive switches Sa1 to Sam are connected to the constant current sources I1 to Im, respectively.

In this manner, ON-drive currents from the constant current sources I1 to Im are supplied to the EL elements connected to the first scan line K1. At this time, a current flowing from the reverse bias voltage source VM to the parasitic capacities of the EL elements transiently flows into the anode side of the EL elements to be turned on through the anode lines, and the parasitic capacities of the EL elements to be turned on are rapidly charged. As a result, rising of light emission of the EL elements to be turned on is relatively quickly performed.

FIGS. 4A and 4B show an operation performed when an ON rate of the EL elements decreases. FIGS. 4A and 4B show supply states of voltages to the EL elements in the reset period and the constant current drive period as in FIGS. 3A and 3B. However, in the example shown in FIGS. 4A and 4B, the EL elements corresponding to the first and second anode lines are turned off, and the EL elements corresponding to the mth anode line are turned on. Therefore, it can be said that the ON rate of the EL elements is 33% in the scope shown in FIGS. 4A and 4B.

In the reset period, as shown in FIG. 4A, the reverse bias voltage VM is applied to the scan lines K1 to Kn. The first and second anode lines A1 and A2 are connected to the ground voltage GND, and the mth anode line Am is connected to the VAM side. In this manner, a voltage difference between both the ends of each of the EL elements connected to the mth anode line Am is eliminated, and an amount of charge accumulated in the parasitic capacities of the EL elements connected to the mth anode line Am becomes zero. On the other hand, a reverse bias voltage obtained by the reverse bias voltage VM is applied to the EL elements connected to the first and second anode lines A1 and A2 controlled to be in an OFF state and charged with the polarity shown in FIG. 4A.

Subsequently, in the constant current drive period, as shown in FIG. 4B, for example, the first scan line K1 to be turned on for scanning is set to the ground voltage GND, and the reverse bias voltage VM is applied to the other scan lines. At this time, the first and second anode lines A1 and A2 controlled to be in an OFF state are set to the ground voltage GND, and the mth anode line Am controlled to be in an ON state is connected to the constant current source Im side.

In this manner, an ON-drive current from the constant current source Im is supplied to the EL elements to be turned on connected to the first scan line K1 and the mth anode line Am. At this time, a current flowing from the reverse bias voltage VM into the parasitic capacities of the EL elements which are not scanned transiently flows into the anode side of the EL elements to be turned on through the anode lines to rapidly charge the parasitic capacities of the EL elements to be turned on. As a result, rising of light emission of the EL elements to be turned on is relatively quickly performed.

In this case, the EL elements not to be turned on have been charged by the reverse bias voltage generated by the reverse bias voltage VM and are not changed in state. For this reason, a transient current from the reverse bias voltage VM through the anode lines A1 and A2 not to be turned on rarely flow into the EL elements. As a result, the reverse bias voltages in the cathode lines K2 to Kn in a non-scanning state are rarely dropped, and a current transiently flowing into the anode side of the EL elements to be turned on for scanning through the cathode lines K2 to Kn in a non-scanning state and the anode line Am to be turned on is larger than that in the state shown in FIG. 3B. In this manner, the degree of rising of luminance at the beginning of light emission of the EL elements to be turned on for scanning is conspicuous more than that in the example shown in FIGS. 3A to 3E.

In short, since charging to the EL elements to be turned on is performed by a current from the VM (sneak current supplied through the parasitic capacities of the EL elements connected to a non-scanning line), and a charging time constant (capacitive load) of an entire display panel changes depending on an ON rate of the EL elements in each scanning operation. For this reason, in particular, an amount of current transiently flowing on the anode side of the EL elements to be turned on changes depending on the ON rate. The change in amount of current causes shadowing.

FIG. 5 typically showing an example of occurrence of shadowing caused by the operation described above. In the display pattern shown in FIG. 5, a double-hatched portion “A” indicates a region in which EL elements are set in an OFF state, and single-hatched portions “B” and “C” indicate regions in which EL elements are in an ON state. As indicated as “A” in FIG. 5, for each scan line, when a rate of OFF elements is high (ON rate is low), “bright horizontal crosstalk” in which the portion indicated by “B” emits light brightly more than the portion indicated by “C” occurs.

The example described above is based on a VM reset method which applies a reverse bias voltage VM to the EL element in a reset operation mode. In contrast to this, in the reset operation mode, in a GND reset method which sets both the ends of EL elements at the ground voltage GND, it is known generally that “dark horizontal crosstalk” in which the portion indicated by “B” in FIG. 5 emits light darkly more than the portion indicated by “C” occurs. The shadowing change in various states by factors such as a display pattern of the display panel, a time constant, or the like.

On the other hand, it is known that, as a dimmer value on a dimmer display which controls the entire brightness of the display panel decreases, the degree of occurrence of the shadowing becomes conspicuous. This phenomenon occurs for the following reason. That is, it is considered that, as the dimmer value is set at a low level, contribution of electric charges flowing through the EL element scanned through a parasitic capacity of an EL element which is not scanned becomes relatively high because light-emission time of the EL element in one scanning period is short or the value of a drive current is small.

### SUMMARY OF THE INVENTION

The present invention has been made in consideration of the problem of shadowing which occurs when an ON rate of EL elements of each scan line is especially low and the problem of the shadowing which conspicuously occurs when a dimmer value obtained by dimmer control is set at a low level, and has as its object to a drive device and a drive method for a light-emitting display panel which can reduce the shadowing to a level at which any problem does not occur in practice.

In a preferable basic aspect of the drive device according to the present invention made to solve the above problem, there is provided a drive device to drive a passive matrix light-emitting display panel having a plurality of scan lines and a plurality of data lines which cross each other, and light-emitting elements connected between the scan lines and the data lines at crossing points of the scan lines and the data lines to emit light, including: a scanning selecting unit to apply a scanning selecting voltage and a non-scanning selecting voltage to each of the scan lines; an ON rate acquiring unit which obtains a rate PN of light-emitting elements to be controlled to emit light in the light-emitting elements connected to the scan lines; and a non-scanning voltage setting unit which can control the non-scanning selecting voltage on the basis of the rate PN obtained by the ON rate acquiring unit.

In a preferable basic aspect of the drive method according to the present invention made to solve the above problem, there is provided a drive method to drive a passive matrix light-emitting display panel having a plurality of scan lines and a plurality of data lines which cross each other, and light-emitting elements connected between the scan lines and the data lines at crossing points of the scan lines and the data lines to emit light, including: the step of obtaining a rate PN of light-emitting elements to be controlled to emit light in the light-emitting elements connected to the scan lines; and the step of controlling a non-scanning selecting voltage applied to a scan line not to be scanned on the basis of the ON ratio PN obtained by the above step and supplying a light-emitting drive current to light-emitting elements to be turned on, the light-emitting elements being connected to a scan line to be scanned.

### BRIEF DESCRIPTION OF THE DRAWINGS

FIG. 1 is a circuit diagram showing an example of a conventional passive matrix display panel and a drive circuit therefor;

FIGS. 2A to 2E are timing charts for explaining an ON-drive operation in the display panel shown in FIG. 1;

FIGS. 3A and 3B are circuit diagrams for explaining an operation performed when an ON rate of light-emitting elements is high according to the timing charts shown in FIGS. 2A to 2E;

FIGS. 4A and 4B are circuit diagrams for explaining an operation performed when the ON rate of the light-emitting elements is low according to the timing charts shown in FIGS. 2A to 2E;

FIG. 5 is a pattern diagram showing an example in which shadowing occurs;

FIG. 6 is a circuit diagram showing a basic configuration of a drive device according to the present invention;

FIG. 7 is a circuit diagram showing a configuration of a non-scanning voltage setting unit shown in FIG. 6;

FIG. 8 is a circuit diagram showing another configuration of the non-scanning voltage setting unit; and

FIG. 9 is a circuit diagram showing still another configuration of the non-scanning voltage setting unit.

### DESCRIPTION OF THE PREFERRED EMBODIMENTS

A drive device for a light-emitting display panel according to the present invention will be described below on the basis of embodiments shown in the drawings. The drive device for a light-emitting display panel according to the invention, as described above, has a basic concept in which a non-scanning selecting voltage is variably controlled depending on a rate PN of light-emitting elements to be turned on for scanning.

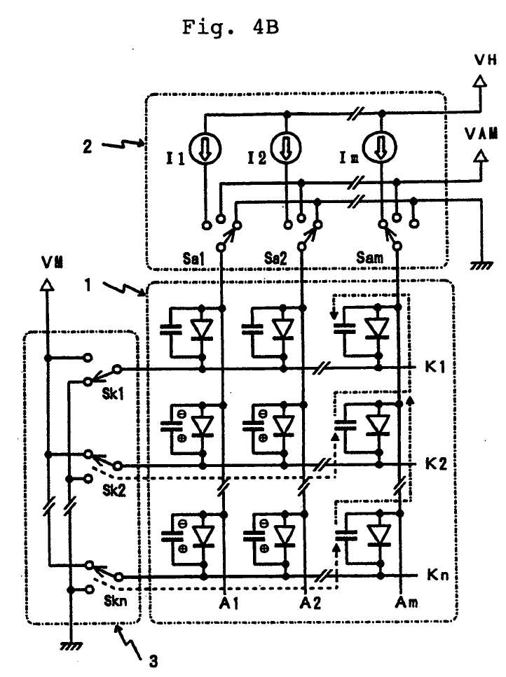

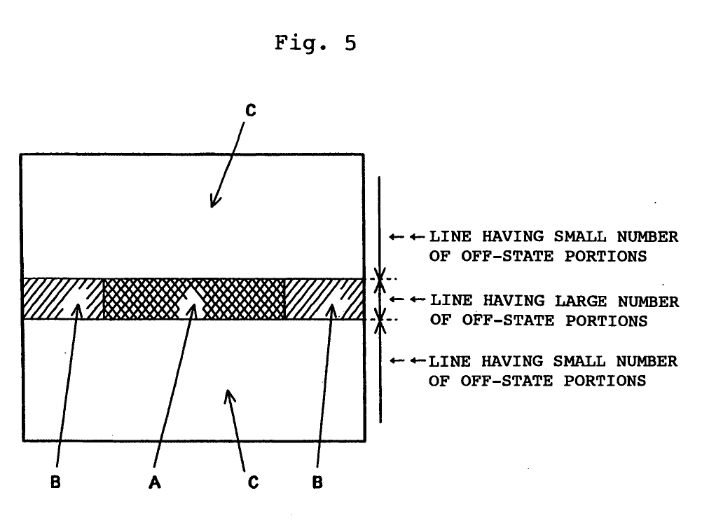

More specifically, as indicated by a broken line in FIG. 4B, an amount of a current (sneak current described above) flowing from a reverse bias voltage VM to an EL element which corresponds to an anode line Am and is not scanned is properly controlled by variably controlling a non-scanning selecting voltage of the reverse bias voltage VM. In this manner, the light-emitting luminance of an EL element to be turned on for scanning is suppressed from rising as described above. As a result, the shadowing can be prevented from occurring.

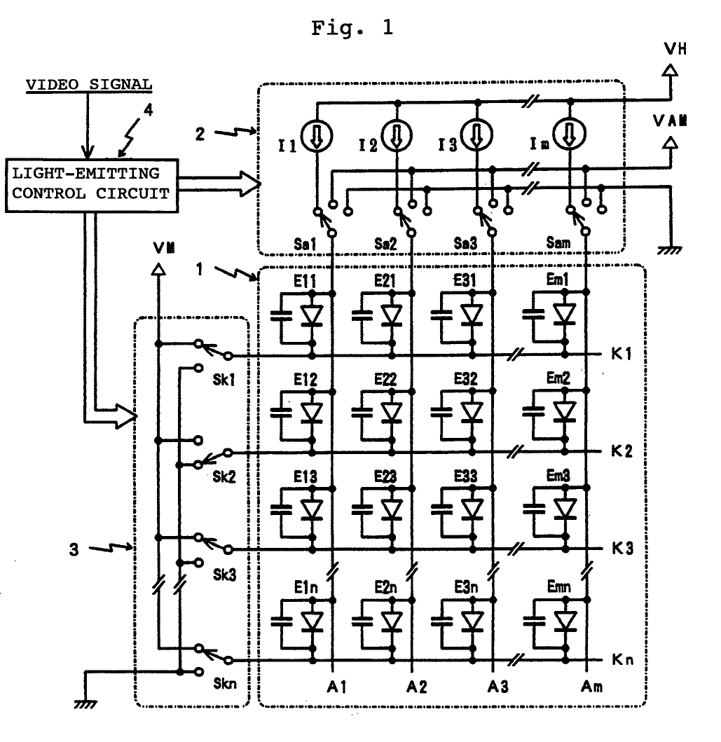

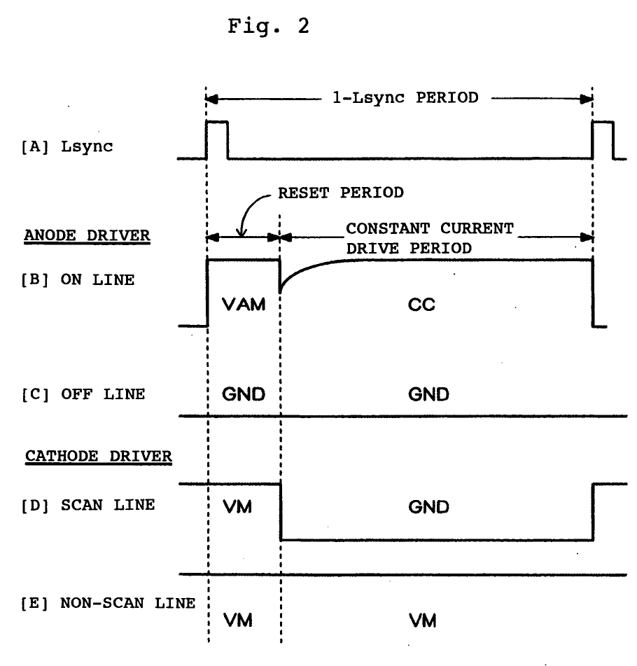

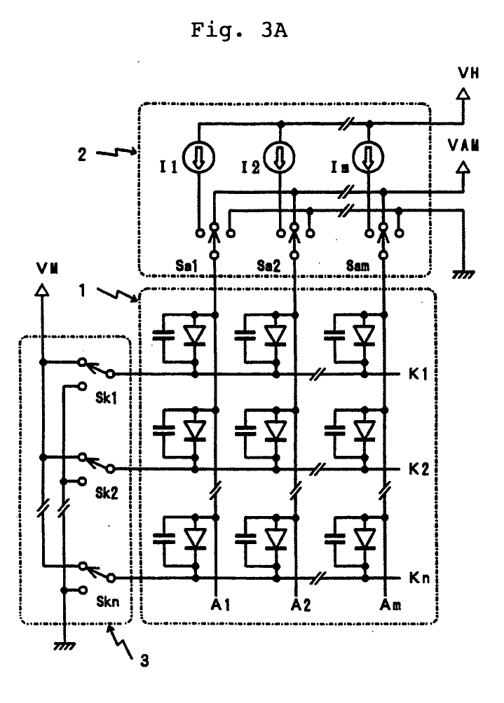

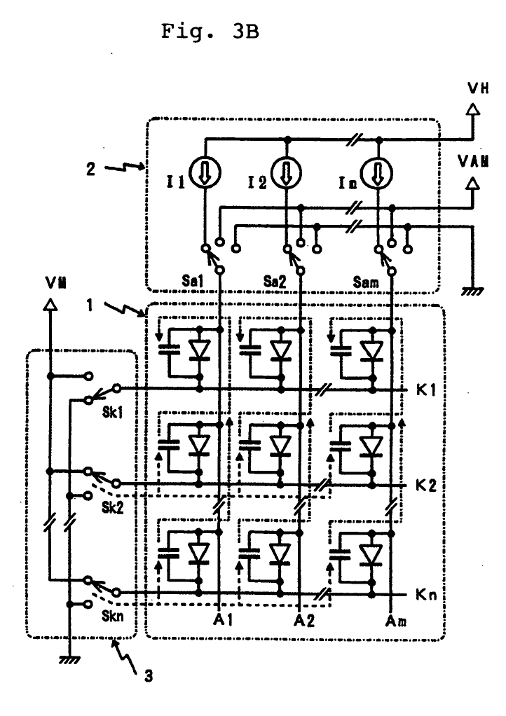

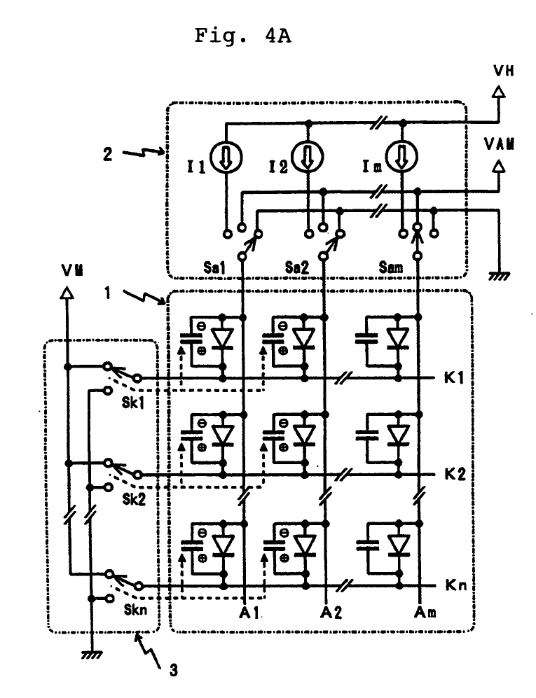

The drive device according to the invention basically employs the same circuit configuration as the configuration shown in FIG. 1 described above, a reset period and a constant current drive period (ON period) are set in synchronism with a scanning synchronous signal as shown in FIGS. 2A to 2E. The same reference numerals (will be described below) denote parts having the same functions as those of the constituent elements shown in the drawings described above.

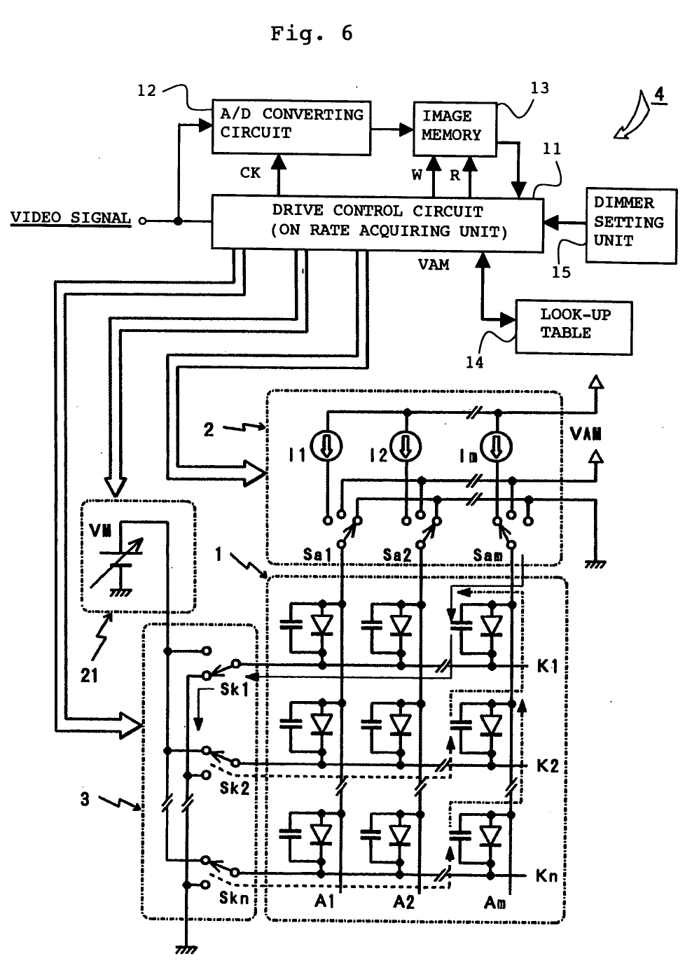

FIG. 6 shows an example obtained by adding a more detailed configuration corresponding to a light-emission control circuit 4 and a configuration which variably controls the reverse bias voltage VM serving as non-scanning selecting voltage to the configuration shown in FIG. 1. An analog video signal is supplied to the light-emission control circuit 4 shown in FIG. 6. More specifically, the analog video signal is supplied to a drive control circuit 11 and an analog/digital (A/D) converting circuit 12 which constitute the light-emission control circuit 4.

The drive control circuit 11 generates a clock signal CK to the A/D converting circuit 12 and a write signal W and a read signal R to an image memory 13 on the basis of a horizontal sync signal and a vertical sync signal in the analog video signal. The drive control circuit 11 is designed to output a switching signal for drive switches in a data driver 2 shown in FIG. 1 and a scan switching signal to a scanning driver 3 serving as a scan selecting unit on the basis of the horizontal sync signal and the vertical sync signal.

The A/D converting circuit 12 operates to perform sampling of an input analog signal on the basis of a clock signal supplied from the drive control circuit 11 and to convert resultant signals into image data corresponding to respective pixels to supply the image data to the image memory 13. The image memory 13 operates to sequentially write the pixel data supplied from the A/D converting circuit 12 in the image memory 13 by the write signal W supplied from the drive control circuit 11.

When a frame memory is employed as the image memory 13, data of one screen (m columns and n rows) on a display panel 1 is written by the write operation. Upon completion of the writing operation of the data of one screen, image data is read from the memory 13 every row (each scanning operation) from the first row to the nth row of a scan line by the read signal R supplied from the drive control circuit 11. The drive control circuit 11 operates to obtain a ratio (ON rate of EL elements of each scan line) PN of EL elements to be controlled to emit light. In other words, the drive control circuit 11 functions as an ON rate acquiring unit for EL elements.

In the configuration, dimmer control data is supplied from a dimmer setting unit 15 to the drive control circuit 11. In this manner, the display panel 1 is designed to perform dimmer display in D (D=1 to d) steps. Dimmer values may be manually set in the dimmer setting unit 15, or a dimmer value may also be automatically set in a mobile device or the like in response to external light.

The drive control circuit 11 operates to obtain non-scanning selecting voltage data corresponding to the ON rate PN in each scanning operation as one form and to supply the non-scanning selecting voltage data obtained from the look-up table 14 to a non-scanning voltage setting unit (reverse bias voltage source VM) indicated by reference numeral 21 in FIG. 6. According to this, depending on an ON rate of the EL elements in each scanning operation, the non-scanning voltage setting unit 21 operates to change a non-scanning selecting voltage (reverse bias voltage). The operation is sequentially executed from the first row to the nth row (N=1 to n) of the scan line in synchronism with the scanning operation of the scanning driver 3.

The non-scanning voltage setting unit 21 is shown as the variable voltage source VM in FIG. 6. The non-scanning voltage setting unit 21 operates such that one terminal (negative terminal) of the non-scanning voltage setting unit 21 is connected to a ground voltage GND and the other terminal (positive terminal) is connected by the scanning driver 3 to scan lines not to be scanned. With this configuration, the non-scanning selecting voltage (reverse bias voltage VM) controlled depending on the ON ratio PN can be applied to the scan lines not to be scanned.

The drive control circuit 11 operates to calculate non-scanning selecting voltage data as another form from the look-up table 14 by the ON rate PN of each scanning operation and the data of the dimmer control to supply the non-scanning selecting voltage data obtained from the look-up table 14 to the non-scanning voltage setting unit indicated by reference numeral 21 in FIG. 6.

According to this, depending on the ON rate of EL elements in each scanning operation and dimmer control data (D=1 to d) set at this time, the non-scanning selecting voltage data read from the look-up table 14 is supplied to the non-scanning voltage setting unit 21. At this time, the look-up table 14 is structured in the form of a map (two-dimensional) from which the non-scanning selecting voltage data can be extracted by the ON rate of EL elements and the dimmer control data.

The ON control state of the EL elements on the display panel 1 shown in FIG. 6 shows a state of an ON period obtained when the ON ratio PN of the EL elements is low as in FIG. 4B as described above. According to this example, as described above, a current transiently flowing on the anode side of the EL elements to be turned on for scanning by the non-scanning selecting voltage (reverse bias voltage source VM) through the cathode lines K2 to Kn in a non-scanning state and the anode line Am to be turned on increases when the ON ratio PN is high. For this reason, the degree of rising of luminance at the beginning of light emission of the EL elements to be turned on for scanning becomes high.

Therefore, the value (level) of the non-scanning selecting voltage (reverse bias voltage source VM) in the non-scanning voltage setting unit 21 is controlled to be low, so that the value of a current transiently flowing from the reverse bias voltage source VM to the anode side of the EL elements to be turned on for scanning can be suppressed. In this manner, the degree of occurrence of shadowing can be effectively reduced.

FIG. 7 shows a concrete configuration of the non-scanning voltage setting unit 21. The non-scanning voltage setting unit 21 shown in FIG. 7 includes a decoder 23. The decoder 23 is designed such that non-scanning selecting voltage data corresponding to an ON rate of EL elements is supplied from the drive control circuit 11 to the decoder 23 as binary data. The decoder 23 is designed such that any one of switches S1 to S4 can be turned on, on the basis of the binary data.

Resistors R1 to R4 having different resistances are connected between one ends of the switches S1 to S4 and the ground voltage GND, and the other ends of the switches S1 to S4 are commonly connected and connected to an operation voltage source VH through a resistor R0. On the other hand, an npn transistor Tr1 which has a base electrode connected to a connection point between the switches S1 to S4 and the resistor R0, a collector electrode connected to the operation voltage source VH, and an emitter electrode connected to the ground voltage GND through a resistor R5.

The npn transistor Tr1 constitutes a buffer amplifier constituted by an emitter follower circuit, and operates such that a divided voltage between the resistor R0 and any one of the resistors R1 to R4 is output from the emitter terminal as the non-scanning selecting voltage (reverse bias voltage) VM. In the state shown in FIG. 7, the switch S1 is an ON state. Therefore, the transistor Tr1 functions such that a non-scanning selecting voltage having a value obtained by subtracting a base-emitter voltage Vbe of the transistor Tr1 from a divided voltage of the operation voltage source VH obtained by the resistor R0 and the resistor R1 is output as the reverse bias voltage VM.

With the configuration of the non-scanning voltage setting unit 21, by the non-scanning selecting voltage data supplied from the drive control circuit 11 on the basis of the ON rate of EL elements in each scanning operation, the decoder 23 turns on any one of the switches S1 to S4. In this manner, a divided voltage is brought by the emitter electrode of the transistor Tr1, so that the non-scanning selecting voltage VM is changed.

Therefore, with the configuration shown in FIG. 7, as described with reference to FIG. 6, the value of a current transiently flowing from the non-scanning selecting voltage (reverse bias voltage source VM) to the anode side of the EL elements to be turned on for scanning can be suppressed by properly selecting the divided voltage. For this reason, the degree of occurrence of shadowing can be effectively reduced.

When the non-scanning selecting voltage data supplied to the decoder 23 is based on the ON rate of EL elements in each scanning operation and dimmer control data set at this time, the shadowing caused by the ON rate of the EL elements can be corrected. In addition, especially in a low-dimmer state, shadowing can be effectively suppressed from occurring.

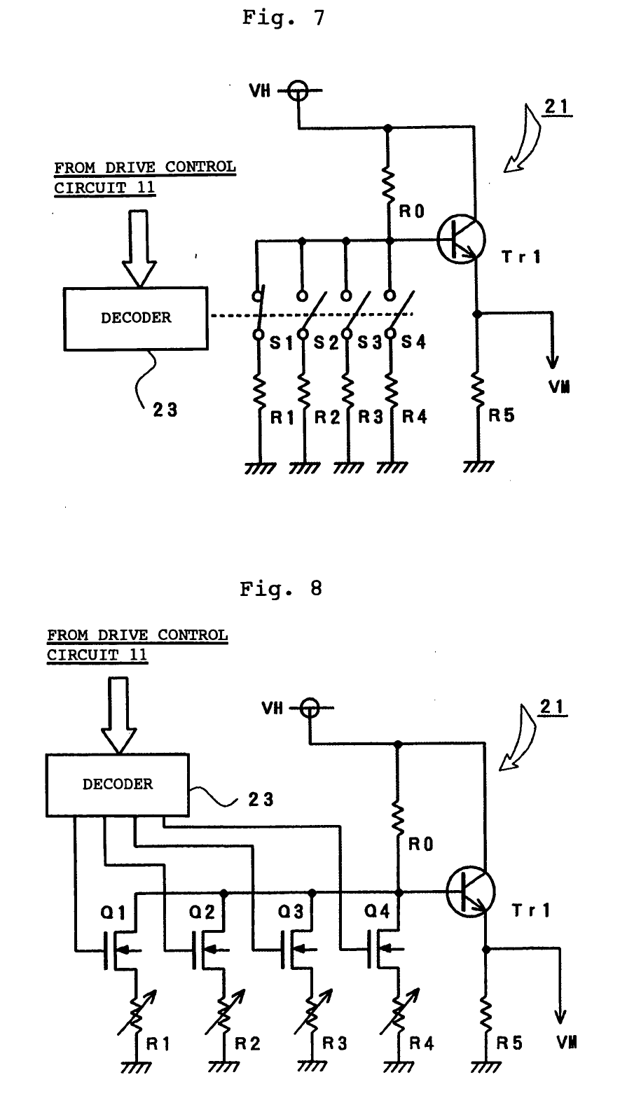

FIG. 8 shows another concrete configuration of the non-scanning voltage setting unit 21. The example shown in FIG. 8 shows a case in which analog switches constituted by FETs are used in place of the switches S1 to S4. More specifically, on the basis of an ON rate of EL elements in each scanning operation or the ON rate and dimmer control data set at this time, the decoder 23 operates such that any one of FETs Q1 to Q4 functioning as analog switches is turned on. Also in this configuration, the same operational effect as that of the configuration shown in FIG. 7 can be obtained.

In the example shown in FIG. 8, although the FETs Q1 to Q4 are functioned as analog switches, respectively, the FETs Q1 to Q4 may be designed such that ON resistances (electric resistances between the drains and the sources) are different from each other when gate voltages are applied to the FETs Q1 to Q4 to turn on the FETs Q1 to Q4. The different ON resistances can be realized by adjusting the gate lengths of the FETs. Therefore, when the FETs having the different ON resistances are employed, the resistors R1 to R4 shown in FIG. 8 can be omitted.

In the configuration shown in FIGS. 7 and 8, any one of the four resistors R1 to R4 is selected. However, five or more resistors can be arranged as a matter of course. Furthermore, for example, the resistors R1 to R4 are controlled such that two or more of the four resistors R1 to R4 are appropriately connected in parallel to each other to make it possible to obtain divided voltages in steps the number of which is larger than that of the above configuration.

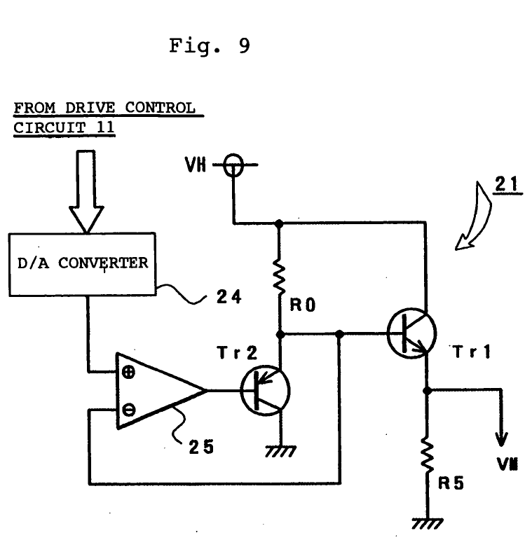

FIG. 9 shows still another concrete configuration of the non-scanning voltage setting unit 21. The non-scanning voltage setting unit 21 shown in FIG. 9 includes a D/A converter 24. The D/A converter 24 is designed such that non-scanning selecting voltage data corresponding to an ON rate of EL elements is supplied as digital data from the drive control circuit 11. An analog voltage converted by the D/A converter 24 is designed to be supplied to the non-inverted input terminal of an operational amplifier 25.

The output terminal of the operational amplifier 25 is connected to the base electrode of a pnp transistor Tr2 having a grounded collector electrode, and the emitter electrode of the transistor Tr2 is connected to the drive voltage source VH through the resistor R0. The emitter electrode of the transistor Tr2 is connected to the base electrode of the transistor Tr1 constituting a buffer amplifier as in the configurations shown in FIGS. 7 and 8 described above, and is connected to the inverted input terminal of the operational amplifier 25.

According to the configuration of the non-scanning voltage setting unit 21, depending on an analog voltage converted by the D/A converter 24, the operational amplifier 25 adjusts an amount of current flowing from the emitter electrode of the transistor Tr2 to the collector electrode. More specifically, a divided voltage output obtained by dividing the drive voltage source VH by the transistor Tr2 and the resistor R0 is generated a the emitter electrode of the transistor Tr2. The non-scanning voltage setting unit 21 operates such that the emitter voltage is output from the emitter electrode of the transistor Tr1 as the non-scanning selecting voltage VM through a buffer amplifier constituted by the transistor Tr1.

The emitter voltage of the transistor Tr2 is supplied as a feedback signal to the inverted input terminal of the operational amplifier 25, so that the linearity of the divided voltage generated by the emitter electrode of the transistor Tr2 corresponding to an analog voltage from the D/A converter 24 is improved.

According to the configuration shown in FIG. 9, depending on a variation in analog voltage converted by the D/A converter 24, the level of the non-scanning selecting voltage (reverse bias voltage) VM is raised or lowered, so that the voltage of a scan line set in a non-scanning state is controlled in each case. Therefore, the value of a current transiently flowing from the reverse bias voltage source VM to the anode side of the EL elements to be turned on for scanning can be appropriately suppressed as described with reference to FIG. 6. In this manner, the degree of occurrence of shadowing can be effectively reduced.

When digital data (non-scanning selecting voltage data) supplied to the D/A converter 24 is based on an ON rate of the EL elements in each scanning operation and dimmer control data set at this time, the shadowing caused by the ON rate of the EL elements can be corrected. In addition, especially in a low-dimmer state, shadowing can be effectively suppressed from occurring.

The embodiment described above explains an example which uses an organic EL element as a light-emitting element arranged on a display panel. Even though another capacitive element is used as the light-emitting element, the same operational effect as described above can be obtained. In the embodiment described above, on the basis of an ON rate of EL elements, non-scanning selecting voltage data is read from the look-up table. However, the non-scanning selecting voltage data may be calculated by a logical operation.

What is claimed is:

1. A drive device to drive a passive matrix light-emitting display panel having a plurality of scan lines and a plurality of data lines which cross each other, and light-emitting elements connected between the scan lines and the data lines at crossing points of the scan lines and the data lines to emit light, comprising:
a scanning selecting unit to apply a scanning selecting voltage or a non-scanning selecting voltage to the respective scan lines; an ON rate acquiring unit which obtains a rate PN of light-emitting elements to be controlled to emit light in the light-emitting elements connected to the scan lines; and a non-scanning voltage setting unit which can control the non-scanning selecting voltage on the basis of the rate PN obtained by the ON rate acquiring unit.

2. A drive device to drive a passive matrix light-emitting display panel having a plurality of scan lines and a plurality of data lines which cross each other, and light-emitting elements connected between the scan lines and the data lines at crossing points of the scan lines and the data lines to emit light, comprising:
a scanning selecting unit to apply a scanning selecting voltage or a non-scanning selecting voltage to the respective scan lines; an ON rate acquiring unit which obtains a rate PN of light-emitting elements to be controlled to emit light in the light-emitting elements connected to the scan lines; a dimmer control unit which causes the display panel to perform dimmer display in D (D=1 to d) steps; and a non-scanning voltage setting unit which can control the non-scanning selecting voltage on the basis of the ON ratio PN obtained by the ON rate acquiring unit and the step D of dimmer control in the dimmer control unit.

3. The drive device for a light-emitting display panel according to claim 1, wherein the non-scanning voltage setting unit includes a voltage dividing unit which generates different divided voltages depending on combinations of a plurality of resistors by non-scanning selecting voltage data obtained on the basis of the ON ratio PN of light-emitting elements to be controlled to emit light and sets the divided voltages as non-scanning voltages.

4. The drive device for a light-emitting display panel according to claim 2, wherein the non-scanning voltage setting unit includes a voltage dividing unit which generates different divided voltages depending on combinations of a plurality of resistors by non-scanning selecting voltage data obtained on the basis of the ON ratio PN of light-emitting elements to be controlled to emit light and the step D of the dimmer control and sets the divided voltages as non-scanning voltages.

5. The drive device for a light-emitting display panel according to claim 1, wherein the non-scanning voltage setting unit includes a D/A converter which converts the non-scanning selecting voltage data obtained on the basis of the ON ratio PN of light-emitting elements to be controlled to emit light into an analog voltage.

6. The drive device for a light-emitting display panel according to claim 2, wherein the non-scanning voltage setting unit includes a D/A converter which converts the non-scanning selecting voltage data obtained on the basis of the ON ratio PN of light-emitting elements to be controlled to emit light and the step D of the dimmer control into an analog voltage.

7. The drive device for a light-emitting display panel according to any one of claims 1 to 6, wherein the light-emitting element is an organic EL light-emitting element having an organic light-emitting function layer constituted by at least one layer between opposing electrodes.

8. A drive method of a light-emitting display panel having a plurality of scan lines and a plurality of data lines which cross each other, and light-emitting elements connected between the scan lines and the data lines at crossing points of the scan lines and the data lines to emit light, including:
the step of obtaining a rate PN of light-emitting elements to be controlled to emit light in the light-emitting elements connected to the scan lines; and
the step of controlling a non-scanning selecting voltage applied to a scan line not to be scanned on the basis of the ON ratio PN obtained by the above step and supplying a light-emitting drive current to light-emitting elements to be turned on, the light-emitting elements being connected to a scan line to be scanned.

9. A drive method of a light-emitting display panel having a plurality of scan lines and a plurality of data lines which cross each other, and light-emitting elements connected between the scan lines and the data lines at crossing points of the scan lines and the data lines to emit light, including:
the step of obtaining a rate PN of light-emitting elements to be controlled to emit light in the light-emitting elements connected to the scan lines and data of dimmer control which causes the display panel to perform dimmer display in D (D=1 to d) steps; and
the step of controlling a non-scanning selecting voltage applied to a scan line not to be scanned on the basis of the ON ratio PN obtained by the above step and the data of the dimmer control and supplying a light-emitting drive current to light-emitting elements to be turned on, the light-emitting elements being connected to a scan line to be scanned.
